(19) United States
(12) Patent Application Publication
(10) Pub. No.: US 2013/0036652 A1
(43) Pub. Date: Feb. 14, 2013

(54) Game changer II

(71) Applicant: Thomas Francis McCallum, III, Stone Harbor, NJ (US)

(72) Inventor: Thomas Francis McCallum, III, Stone Harbor, NJ (US)

(21) Appl. No.: 13/068,769

(22) Filed: Aug. 8, 2011

(51) Int. Cl. A01K 97/00

(52) U.S. Cl. 43/4

(57) ABSTRACT

The Game Changer II (GCII) is a device designed to enhance the performance and presentation of rubber fishing baits used in fishing. GCII's sliding plunger bar allows for a straight and centered hole to be pre-set in rubber fishing baits. This pre-set hole is pivotal when applying the hook or jig head to the rubber bait in-that it allows the hook to follow the pre-set hole through the center of the bait.

GCII is a plastic, single hinge unit with 2 moving parts (the lid and the sliding plunger bar) and 2 separate trays (1 for larger baits and 1 for smaller baits). With the lid in the open position and the sliding plunger bar (see diagram 4) in the extended position, the rubber bait is laid in the tray with the top of the rubber bait. flush against the inner wall of the GCII and the head of the bait at the plunger hole. Close the lid. Once the lid is closed apply minimal pressure on both the top and the bottom of the GCII. This will apply pressure on the rubber bait allowing the traction ribs (see diagram 4) to grip the rubber bait and hold it in place for the plunger bar compression. Next, using you free hand, compress the plunger bar handle all the way toward the unit using light pressure. Once this step is complete the hole has been set. Return the plunger bar to the extended position, open the lid and remove the bait.

### BACKGROUND

Rubber fish baits are commonly used in fresh and saltwater fishing. The problem with rubber fish baits is applying the hook properly. The Game Changer II allows the fisherman to place a pre-set hole in the rubber fish bait, allowing the hook to feed into the center of the rubber fish bait, enhancing the performance and presentation of the bait. The Game Changer II can have one or multiple trays of different depths to accommodate smaller and larger rubber fishing baits. Fish scents may also be added to the plunger pins prior to depressing into the bait; this injects scent into the bait. Most rubber fishing baits are petroleum products and have seen a drastic price increase in recent years. If the hook is not centered in bait, the bait is basically useless and usually discarded. The GCII will greatly reduce the number of wasted rubber fishing baits.

### DESCRIPTIONS OF FIGURES

FIG. 1: Shows handle, left and right plungers and center stabilization bar.

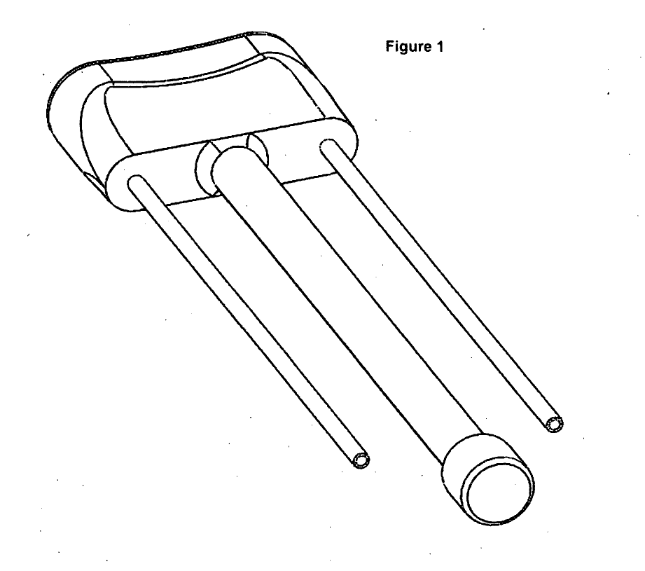

FIG. 2: Hinged lid of Game Changer II (GCII) with traction ribs for stabilizing rubber bait.

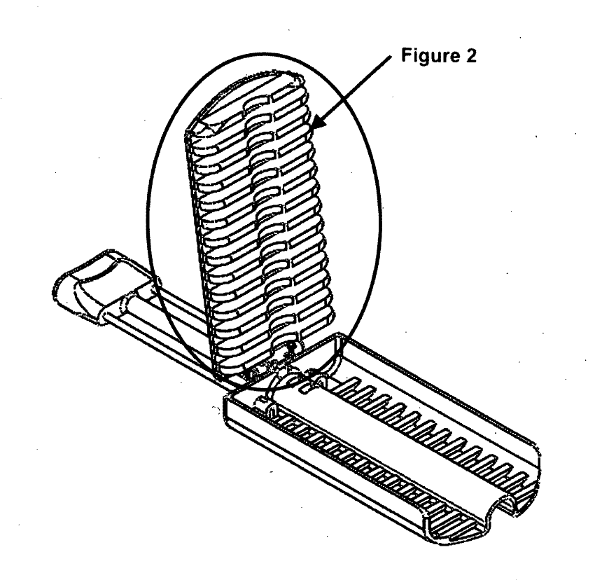

FIG. 3: Lower right tray of GCII with traction ribs for stabilizing rubber bait.

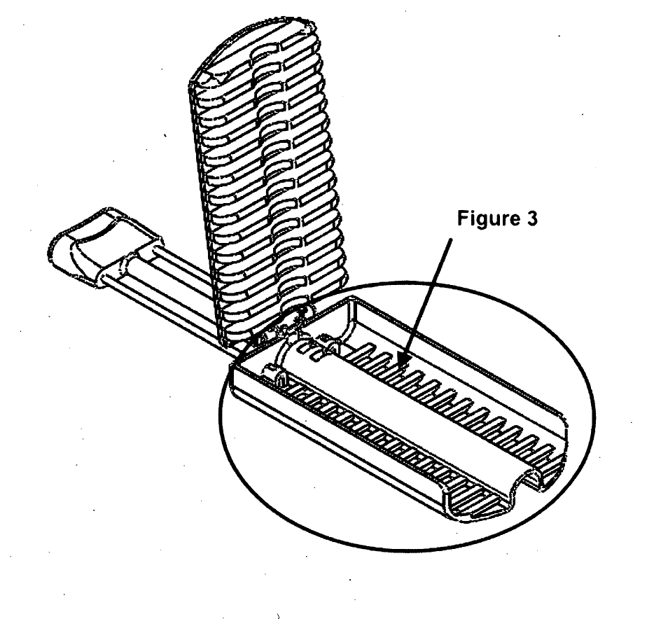

FIG. 4: Lower left tray of GCII with traction ribs for stabilizing rubber bait.

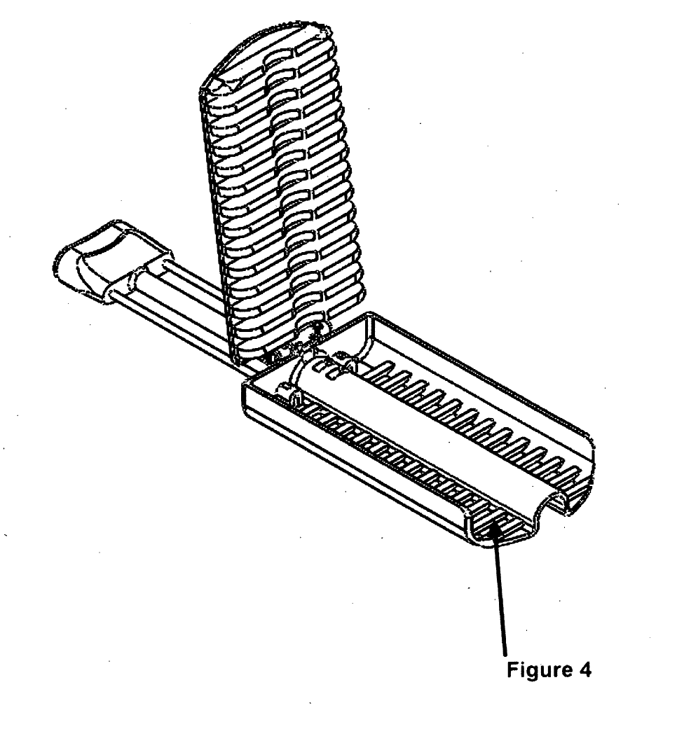

FIG. 5: Depicts rubber bait placement in lower tray prior to plunging the handle.

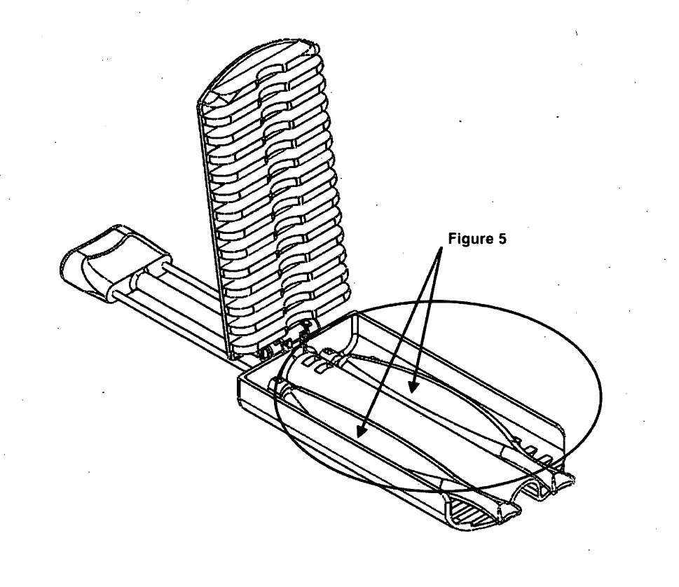

FIG. 6: Depicts GCII in closed position with rubber bait in place, prior to plunging the handle.

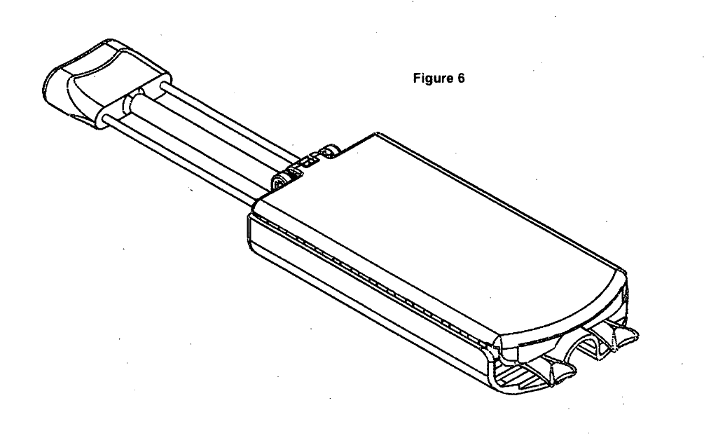

FIG. 7: Depicts GCII after handle has been plunged.

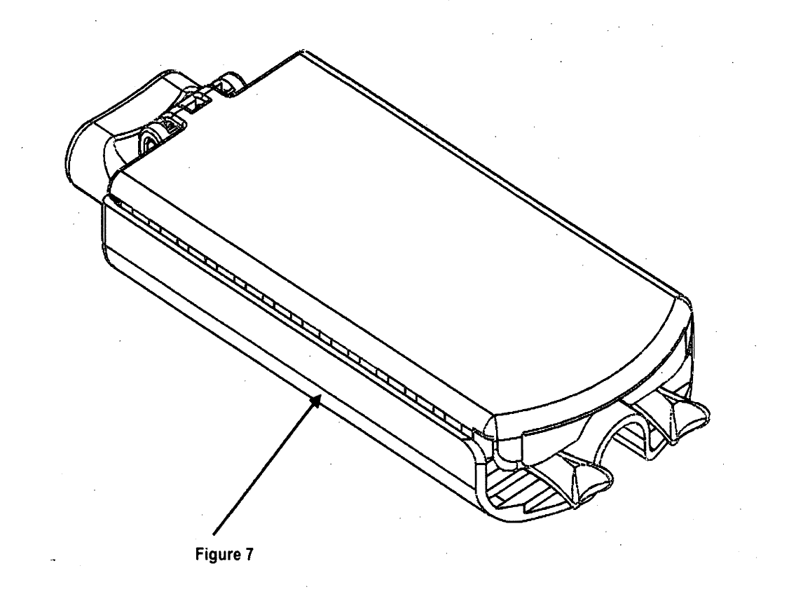

FIG. 8: Depicts side view of bait being plunged.

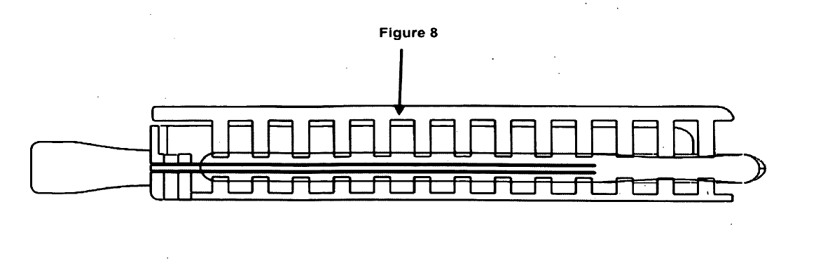

1. GCII may have at least one plunger pin and may vary in size to accommodate rubber fishing baits of varying shapes and sizes. GCII is used to pre-set holes in rubber fishing baits so that hook application will be centered and straight, so that it casts, retrieves and presents in a more effective manner.
GCII can be used to inject fish scents into rubber fishing baits.
GCII can be used to pre-set holes for rigging other types of rubber fishing baits or fishing line and leaders.
